(19) United States
(12) Patent Application Publication
(10) Pub. No.: US 2019/0372110 A1
(43) Pub. Date: Dec. 5, 2019

(54) CATHODE ACTIVE MATERIAL PRECURSOR AND MANUFACTURING METHOD THEREOF, AND CATHODE ACTIVE MATERIAL

(71) Applicants: POSCO, Pohang-si (KR); Research Institute of Industrial Science & Technology, Pohang-si (KR)

(72) Inventors: Sang Cheol Nam, Seoul (KR); Jung Hoon Song, Seoul (KR)

(21) Appl. No.: 16/432,681

(22) Filed: Jun. 5, 2019

Related U.S. Application Data
(63) Continuation-in-part of application No. PCT/KR2017/013841, filed on Nov. 29, 2017.

(30) Foreign Application Priority Data
Dec. 5, 2016 (KR) 10-2016-0164541

(51) Int. Cl. H01M 4/36; H01M 4/525; H01M 4/505; H01M 10/0525; C01G 53/04

(52) U.S. Cl. CPC H01M 4/366; H01M 4/525; H01M 2004/028; H01M 10/0525; C01G 53/04; H01M 4/505

(57) ABSTRACT

This proposes a minimum core radius for nickel-based metal hydroxide particles having a core-shell gradient (CSG) in which a concentration of nickel in a core portion is constantly maintained and a concentration of nickel in a shell portion is sharply decreased.

### TECHNICAL FIELD

This relates to a positive electrode active material precursor, a preparation method thereof, and a positive electrode active material.

### BACKGROUND ART

A positive electrode active material, which is one of constituent elements of a lithium rechargeable battery, not only directly contributes to performance of battery energy, but also serves as a factor in determining a cycle-life characteristic.

In this connection, studies on nickel-based lithium metal oxides having a layered structure such as so-called NCM have been actively performed, and an increase in a content of nickel (Ni) may lead to higher capacity.

However, if a molar content of nickel in the nickel-based lithium metal oxide is increased, the structure becomes unstable. To solve this problem, methods such as doping, coating, and formation of a concentration gradient are known.

However, for nickel-based lithium metal oxide particles having an unstable structure, uniformly doping interiors thereof or uniformly coating surfaces thereof is very difficult. It is also known that nickel-based lithium metal oxide particles having a concentration gradient have an average molar content of nickel that is varied depending on the particle size thereof.

In the meantime, attempts have been made to increase energy density of the positive electrode by mixing two kinds of positive electrode active materials having different particle sizes at a certain ratio. This is a technique that is capable of integrating a large amount of positive electrode active material within a unit volume by filling gaps between large-size particles (hereinafter referred to as “large diameter particles”) with small-size particles (hereinafter referred to as “small diameter particles”) by a so-called bi-modal technique.

It is first necessary to prepare large diameter particles and small diameter particles in order to implement such bi-modal technique. However, it is known that it is difficult to uniformly control internal composition in the case of large diameter particles of 5 μm or more, and further it is very difficult to uniformly control an average molar content of nickel, a shape of the concentration gradient, the doping, the surface coating, and the like for each particle size.

### DISCLOSURE

In order to solve the above-mentioned problems, the present invention proposes a minimum core radius to be implemented as a large diameter active material for nickel-based metal hydroxide particles having a core-shell gradient (CSG) in which a concentration of nickel in a core portion is constantly maintained and a concentration of nickel in a shell portion is sharply decreased.

An exemplary embodiment of the present invention provides a positive electrode active material precursor for a lithium rechargeable battery, including: a core portion having a constant molar content of nickel; and a shell portion surrounding an outer surface of the core portion and having a concentration gradient in which a molar content of nickel gradually decreases in a direction from an interface with the core portion to an outermost portion thereof, wherein the positive electrode active material precursor includes a nickel-based metal hydroxide particle having a value of 50% or more of Formula 1:

R1/(R1+D1)*100% [Formula 1]

wherein, in Formula 1, R1 indicates a radius of the core portion in the nickel-based metal hydroxide particle, and D1 indicates a thickness of the shell portion in the nickel-based metal hydroxide particle.

An exemplary embodiment of the present invention provides a preparation method of a positive electrode active material precursor for a lithium rechargeable battery, including: a preparing step of a first metal salt aqueous solution and a second metal salt aqueous solution, each of which contains a nickel source material, a dissimilar metal source material, and water, wherein molar concentrations of the nickel source material are different in the first metal salt aqueous solution and the second metal salt aqueous solution; a first co-precipitation step of forming a core portion by supplying the first metal salt aqueous solution to a reactor having a pH that is constantly maintained, to which a chelating agent is supplied; and a second co-precipitation step of forming a shell portion surrounding an outer surface of the core portion by gradually decreasing a supply rate of the first metal salt aqueous solution and by gradually increasing a supply rate of the second metal salt aqueous solution, after the first co-precipitation step, wherein a nickel-based metal hydroxide particle including the core portion and the shell portion may be obtained in the second co-precipitation step, and the first co-precipitation step and the second co-precipitation step are controlled to obtain a value of 50% or more of Formula 1 for the obtained nickel-based metal hydroxide particle:

R1/(R1+D1)*100% [Formula 1]

wherein, in Formula 1, R1 indicates a radius of the core portion in the nickel-based metal hydroxide particle, and D1 indicates a thickness of the shell portion in the nickel-based metal hydroxide particle.

An exemplary embodiment of the present invention provides a positive electrode active material for a lithium rechargeable battery, including: a core portion having a constant molar content of nickel; and a shell portion surrounding an outer surface of the core portion and having a concentration gradient in which a molar content of nickel gradually decreases in a direction from an interface with the core portion to an outermost portion thereof, wherein the positive electrode active material precursor includes a nickel-based lithium metal oxide particle having a value of 50% or more of Formula 3:

R2/(R2+D2)*100% [Formula 3]

wherein, in Formula 3, R2 indicates a radius of the core portion in the nickel-based metal oxide particle, and D2 indicates a thickness of the shell portion in the nickel-based metal oxide particle.

For a nickel-based metal hydroxide particle having a CSG-type concentration gradient, it is possible to uniformly control an internal composition for each particle size (an average molar content of nickel, a form of the concentration gradient, etc.) by suggesting a minimum core radius to be embodied as a large particle-diameter active material.

### DESCRIPTION OF THE DRAWINGS

FIG. 1 schematically illustrates a profile for each Ni content in Example 1 and Comparative Example 1.

FIG. 2A and FIG. 2B respectively illustrate particle size analysis (PSA) results for each positive electrode active material before classification in Example 1 and Comparative Example 1.

FIG. 3A to FIG. 3E respectively illustrate SEM photographs for each diameter classified in Example 1 (however, scale bars in FIG. 3A to FIG. 3E are 50 μm).

FIG. 4A to FIG. 4D respectively illustrate SEM photographs for each diameter classified in Comparative Example 1 (however, scale bars in FIG. 4A to FIG. 4D are 20 μm).

FIG. 5A illustrates results of measuring DSC thermal characteristics for each positive electrode active material before (reference) and after classification in Example 1.

FIG. 5B illustrates results of measuring DSC thermal characteristics for each positive electrode active material before (reference) and after classification in Comparative Example 1.

FIG. 6 illustrates results of measuring a DC-IR increase ratio of a positive electrode active material before classification according to Example 1 and Comparative Example 1.

### MODE FOR INVENTION

Hereinafter, exemplary embodiments of the present invention will be described in detail. However, it should be understood that the exemplary embodiments are merely examples, the present invention is not limited thereto, and the present invention is only defined by the scope of the following claims.

In this specification, particle size D0.9 indicates a particle size when active material particles having various particle sizes such as 0.1, 0.2, 0.3, . . . , 3, 5, 7, . . . , 10, 20, and 30 μm are accumulated up to a 0.9% by volume ratio, D10 indicates a particle size when they are accumulated up to a 10% by volume ratio, D50 indicates a particle size when they are accumulated up to a 50% by volume ratio, D60 indicates a particle size when they are accumulated up to a 60% by volume ratio, and D95 indicates a particle size when they are accumulated up to a 95% by volume ratio.

### Positive Electrode Active Material Precursor

An exemplary embodiment of the present invention provides a positive electrode active material precursor for a lithium rechargeable battery, including: a core portion having a constant molar content of nickel; and a shell portion surrounding an outer surface of the core portion and having a concentration gradient in which a molar content of nickel gradually decreases in a direction from an interface with the core portion to an outermost portion thereof, wherein the positive electrode active material precursor includes a nickel-based metal hydroxide particle having a value of 50% or more of Formula 1.

R1/(R1+D1)*100% [Formula 1]

In Formula 1, R1 indicates a radius of the core portion in the nickel-based metal hydroxide particle, and D1 indicates a thickness of the shell portion in the nickel-based metal hydroxide particle.

The positive electrode active material precursor provided in the present exemplary embodiment includes a nickel-based metal hydroxide particle having a core-shell gradient (CSG) having the core portion in which a high concentration of nickel is constantly maintained and the shell portion in which the concentration of nickel is sharply reduced. Specifically, the CSG type is advantageous for stabilizing a structure by maintaining the molar content of nickel in the core portion at a high level to increase capacity and by increasing a molar content of a dissimilar metal (e.g., Mn, Co, Al, or the like) while reducing the molar content of nickel in the shell portion.

Further, in the exemplary embodiment of the present invention, for a nickel-based metal hydroxide particle having the CSG-type, it is possible to uniformly control an internal composition (an average molar content of nickel, a form of the concentration gradient, etc.) for each particle size by suggesting a minimum core radius to be embodied as a large particle-diameter active material through Formula 1.

Generally, a nickel-based metal hydroxide water particle having a concentration gradient is prepared by a co-precipitation method by using a batch-type reactor.

Accordingly, a plurality of nickel-based metal hydroxide particles having a narrow Gaussian distribution are prepared, as compared with a case of using a continuous stirred-tank reactor (CSTR).

Nevertheless, the nickel-based metal hydroxide particles prepared to have the concentration gradient by using the batch-type reactor have the internal composition (an average molar content of nickel, a form of a concentration gradient, etc.) that is different depending on sizes thereof.

This problem is exacerbated when the nickel-based metal hydroxide particles having a large size are prepared, and thus the internal composition for each particle size of the large-diameter particles is nonuniform, resulting in the restriction of implementation of the bi-modal active material.

For example, a step of forming the core portion by supplying the first metal salt aqueous solution to a reactor having a pH that is constantly maintained, to which a chelating agent is supplied at a constant rate, is referred to as a first co-precipitation step for convenience sake. After the first co-precipitation step, a shell portion may be continuously formed on a surface of the core portion by gradually decreasing a supply rate of the first metal salt aqueous solution and by gradually increasing a supply rate of the second metal salt aqueous solution. This step is referred to as a second co-precipitation step for convenience sake. As a result, a plurality of nickel-based metal hydroxide particles having diameters that form a Gaussian distribution may be obtained, and each particle may have a CSG form.

Generally, it is known that the first co-precipitation step is performed for about 5 hours, and the first co-precipitation step and the second co-precipitation step are performed for a total of about 20 hours, to obtain a plurality of nickel-based metal hydroxide particles having a value of less than 50% of Formula 1. In this case, as described above, the internal composition (an average molar content of nickel, a form of a concentration gradient, etc.) is different depending on the sizes of the particles because supply tanks of the metal salt aqueous solution are connected in series.

On the other hand, as in another exemplary embodiment of the present invention to be described later, a plurality of nickel-based metal hydroxide particles having a value of 50% or more of Formula 1 may be obtained by appropriately adjusting an execution time of the first co-precipitation step and a total execution time of the first co-precipitation step and the second co-precipitation step.

In this case, the internal composition (an average molar content of nickel, a form of a concentration gradient, etc.) may be made uniform, even when nickel-based metal hydroxide particles having a large size are prepared by using supply tanks that are connected in series. Specifically, for example, a difference in Ni content between the nickel-based metal hydroxide particles may be 3% or less, more specifically 2.5% or less or 2.0% or less.

Specifically, in the exemplary embodiment of the present invention, the value of Formula 1 may be, e.g., 60% or more, 70% or more, 75% or more, or 83% or more. In addition, the value of Formula 1 may be greater than less equal to 97%. In this case, a length of the core portion may be controlled to be, e.g., 2.5 μm or more and less than 24.5 μm, or 2.5 μm or more and less than 16.5 μm. When the length of the core portion is less than 2.5 μm, an effect of improving a heat generation amount is not exhibited, and when the length of the core portion is 24.5 μm or more, an initial resistance is greatly increased, and the performance of the lithium rechargeable battery using a positive electrode active material is greatly reduced. As such, when the value of Equation 1 is at least 50% or more, the heat generation amount of the positive electrode active material manufactured by using the precursor of the present exemplary embodiment may be dramatically reduced, thereby realizing a positive electrode active material with remarkably improved thermal stability.

In other words, in the present exemplary embodiment, the positive electrode active material resulting from the nickel-based metal hydroxide particles may have a heat generation amount of 650 J/g or less, more specifically 600 J/g or less, or 550 J/g or less, as measured by differential scanning calorimetry in a range of 210° C. to 230° C.

A detailed process will be described later, and a positive electrode active material precursor including the nickel-based metal hydroxide particles will now be described in detail.

Size of Nickel-Based Metal Hydroxide Particles

The nickel-based metal hydroxide particles may be a large particle-diameter active material precursor having a D50 of 10 μm to 30 μm in order to realize a large particle-diameter active material and a bi-modal active material based thereon. Specifically, the nickel-based metal hydroxide particles may have a D50 particle diameter that is in a range of 10 to 25 μm or 10.5 to 20 μm.

Internal Composition of Nickel-Based Metal Hydroxide Particles

The nickel-based metal hydroxide particles may have an average composition represented by the following Formula 1 for each particle size of, e.g., D50:

Ni_{1-w1-x1-y1-z1}Co_{w1}M1ₓ₁M2_{y1}M3_{z1}(OH)₂₋ₚ₁Xₚ₁ [Chemical Formula 1]

wherein, in Chemical Formula 1, each of M1, M2, and M3 is one element selected from the group consisting of Mn, Al, Mg, Zr, Sn, Ca, Ge, Ga, B, Ti, Mo, Nb, and W, X is one element selected from the group consisting of F, N, and P, and each of w1, x1, y1, z1, and p1 satisfies a following corresponding inequality: 0<w1≤0.2, 0<x1≤0.2, 0≤y1≤0.1, 0≤z1≤0.1, 0<w1+x1+y1+z1≤0.4, and 0≤p1≤0.1.

This indicates that an average molar content of nickel is a high concentration of 60% or more in an entire region of the nickel-based metal hydroxide particle including the core portion and the shell portion.

For example, in Formula 1, M1 may indicate Mn, and each of w1, x1, y1, z1, and p1 may satisfy a following corresponding inequality: 0<w1≤0.1, 0<x1≤0.1, y1=z1=p1=0, 0<w1+x1+y1+z1≤0.2 or 0<w1+x1+y1+z1≤0.18.

In the present exemplary embodiment, it is possible to realize a positive electrode active material which has excellent thermal stability and resistance characteristics while containing nickel at a high concentration.

Specifically, the nickel-based metal hydroxide particles may have a composition of the core portion represented by the following Formula 2 for each particle size of, e.g., D50:

Ni_{1-w2-x2-y2-z2}Co_{w2}M1ₓ₂M2_{y2}M3_{z2}(OH)₂₋ₚ₂Xₚ₂ [Chemical Formula 2]

wherein, in Chemical Formula 2, each of M1, M2, and M3 is one element selected from the group consisting of Mn, Al, Mg, Zr, Sn, Ca, Ge, Ga, B, Ti, Mo, Nb, and W, X is one element selected from the group consisting of F, N, and P, and each of w2, x2, y2, z2, and p2 satisfies a following corresponding inequality: 0≤w2≤0.1, 0≤x2≤0.1, 0≤y2≤0.1, 0≤z2≤0.1, 0≤w2+x2+y2+z2≤0.2, and 0≤p2≤0.05.

This indicates that the molar content of nickel in the entire region of the core portion in the nickel-based metal hydroxide particle is 80% or more, which basically means that it can contain a higher level of nickel than the average composition.

For example, in Formula 2, M1 may indicate Mn, and each of w2, x2, y2, z2, and p2 may satisfy a following corresponding inequality: 0<w2≤0.05, 0<x2≤0.05, y2=z2=p2=0, and 0<w2+x2+y2+z2≤0.1.

In addition, for each particle size of, e.g., D50, the nickel-based metal hydroxide particles may be represented by Formula 2 at the interface with the core portion, and is represented by Formula 3 at the outermost portion, wherein molar contents of nickel (Ni), M1, M2, and M3 gradually change from the interface to the outermost portion:

Ni_{1-w3-x3-y3-z3}Co_{w3}M1ₓ₃M2_{y3}M3_{z3}(OH)₂₋ₚ₃Xₚ₃ [Chemical Formula 2]

wherein, in Chemical Formula 3, each of M1, M2, and M3 is one element selected from the group consisting of Mn, Al, Mg, Zr, Sn, Ca, Ge, Ga, B, Ti, Mo, Nb, and W, X is one element selected from the group consisting of F, N, and P, and each of w3, x3, y3, z3, and p3 may satisfy a following corresponding inequality: 0<w3≤0.3, 0<x3≤0.3, 0≤y3≤0.1, 0≤z3≤0.1, 0<w3+x3+y3+z3≤0.5, and 0≤p3≤0.1.

This indicates that the molar content of nickel is 80% or more at the interface with the core portion and is 60% or more in the outermost portion in the nickel-based metal hydroxide particle, and having a concentration gradient in which the molar content of nickel gradually decreases from the interface to the outermost portion. In addition, the metals (i.e., M1, M2, and M3) other than nickel have a concentration gradient in which the molar content gradually increases from the interface to the outermost portion.

For example, in Formula 3, M1 may indicate Mn, and each of w3, x3, y3, z3, and p3 may satisfy a following corresponding inequality: 0<w3≤0.25, 0<x3≤0.25, y3=z3=p2=0, and 0<w3+x3+y3+z3≤0.5.

The nickel-based metal hydroxide particle may have a stable structure according to a composition of the shell portion of Formula 3 while accomplishing a high capacity according to a total composition of Formula 1 and a composition of the core portion of Formula 2.

In the present exemplary embodiment, the nickel metal hydroxide particle has an angle formed by a curve representing the nickel molar content of the core portion and a curve representing the nickel molar content of the shell portion that is in the range of 95.1° to 141.3° or 95.1° to 126.3°. That is, when the angle formed by the curve representing the nickel molar content of the core portion and the curve representing the nickel molar content of the shell portion satisfies the above range, the metal elements in the positive electrode active material particles may exist at a uniform concentration, thereby improving the charge/discharge characteristic, the cycle-life characteristic, the thermal stability, and the resistance characteristic of the lithium rechargeable battery.

### Preparation Method of Positive Electrode Active Material Precursor

An exemplary embodiment of the present invention provides a preparation method of a positive electrode active material precursor for a lithium rechargeable battery, including: a preparation step of a first metal salt aqueous solution and a second metal salt aqueous solution, each of which contains a nickel source material, a dissimilar metal source material, and water, wherein molar concentrations of the nickel source material are different in the first metal salt aqueous solution and the second metal salt aqueous solution; a first co-precipitation step of forming a core portion by supplying the first metal salt aqueous solution to a reactor having a pH that is constantly maintained, to which a chelating agent is supplied; and a second co-precipitation step of forming a shell portion surrounding an outer surface of the core portion by gradually decreasing a supply rate of the first metal salt aqueous solution and by gradually increasing a supply rate of the second metal salt aqueous solution, after the first co-precipitation step, wherein a nickel-based metal hydroxide particle including the core portion and the shell portion may be obtained in the second co-precipitation step, and the first co-precipitation step and the second co-precipitation step are controlled to obtain a value of 50% or more of Formula 1 for the obtained nickel-based metal hydroxide particle:

R1/(R1+D1)*100% [Formula 1]

wherein, in Formula 1, R1 indicates a radius of the core portion in the nickel-based metal hydroxide particle, and D1 indicates a thickness of the shell portion in the nickel-based metal hydroxide particle.

Specifically, an execution time of the first co-precipitation step may be proportional to the radius R1 of the core portion, and a formation time of the shell portion may be proportional to the thickness D1 of the shell portion.

In this regard, the first co-precipitation step and the second co-precipitation step may be controlled to satisfy Formula 2:

log T1/log(T1+T2)≈R1/(R1+D1) [Formula 2]

wherein, in Formula 2, T1 is an execution time of the first co-precipitation step, and T2 is an execution time of the second co-precipitation step.

Hereinafter, process characteristics and of each of the above steps will be described except for the description overlapping with that described above.

Execution Times of First Co-Precipitation Step and Second Co-Precipitation Step

The execution times of the first co-precipitation step and the execution time of the second co-precipitation step may be appropriately controlled such that the value of Formula 1 is 50% or more, specifically 60% or more, 70% or more, 75% or more, or 83% or more.

In addition, the value of Formula 1 may be appropriately controlled to be 97% or less.

First Co-Precipitation Step (Core Portion Formation Step)

Specifically, the first co-precipitation step may be performed for 10 hours or more. Accordingly, particles having a radius of R1 from a center and a constant molar content in the entire region may be precipitated.

This is generally twice as long as a time required to adjust a core portion formation time to about 5 hours. It is advantageous to prepare a large particle-diameter active material having a uniformly controlled internal composition (an average molar content of nickel, a form of the concentration gradient, etc.) for each particle size by performing the second co-precipitation step that satisfies Formula 2 while forming a core portion with a long radius by performing the first co-precipitation step for 10 hours or more.

Meanwhile, the first metal salt aqueous solution used in the first co-precipitation step may be a mixture of a nickel source material, a dissimilar metal source material, and water so as to satisfy a stoichiometric molar ratio of Formula 2 described above.

The nickel source material is a material in which nickel positive ions and any negative ions are ion-bonded, and is not particularly limited as long as it is dissolvable in water and dissociated into positive ions and negative ions.

In addition, the dissimilar metal source material is a material in which positive ions of a metal other than nickel (e.g., Mn, Co, Al, etc.) and any negative ions are ion-bonded, and is not particularly limited as long as it is dissolvable in water and dissociated into positive ions and negative ions. For example, it may include one of a Co source material, a Mn source material, an Al source material, a Mg source material, a Zr source material, a Sn source material, a Ca source material, a Ge source material, a Ga source material, a B source material, a Ti source material, a Mo source material, a Nb source material, and a W source material, or a mixture of two or more thereof.

Second Co-Precipitation Step (Shell Portion Formation Step)

In addition, in the second co-precipitation step, shell portions may be formed by using the particles precipitated in the first co-precipitation step as core portions to have a thickness of D1 from surfaces of the core portions and a molar content of nickel that gradually decreases in a thickness direction from interfaces with the surfaces of the core portions, and nickel-based metal hydroxide particles formed to include the core portion and the shell portion may be obtained.

An execution time of the second co-precipitation step may be determined by considering the execution time of the first co-precipitation step and a value of the second co-precipitation step.

The second metal salt aqueous solution used in the second co-precipitation step may be a mixture of a nickel source material, a dissimilar metal source material, and water so as to satisfy a stoichiometric molar ratio of Formula 3 described above.

The nickel source material and the dissimilar metal source material are as described above.

### Positive Electrode Active Material

An exemplary embodiment of the present invention provides a positive electrode active material for a lithium rechargeable battery, including: a core portion having a constant molar content of nickel; and a shell portion surrounding an outer surface of the core portion and having a concentration gradient in which a molar content of nickel gradually decreases in a direction from an interface with the core portion to an outermost portion thereof, wherein the positive electrode active material precursor includes a nickel-based lithium metal oxide particle having a value of 50% or more of Formula 3:

R2/(R2+D2)*100% [Formula 3]

wherein, in Formula 3, R2 indicates a radius of the core portion in the nickel-based metal oxide particle, and D2 indicates a thickness of the shell portion in the nickel-based metal oxide particle.

The positive electrode active material according to the exemplary embodiment of the prevent invention may be prepared based on the positive electrode active material precursor described above. Accordingly, a description related to a CSG form of the positive electrode active material, and a relationship between the radius of the core portion and the thickness of the shell portion of the core portion (i.e., Formula 2), correspond to the aforementioned description related to the positive electrode active material precursor.

Specifically, the positive electrode active material may be obtained by mixing the positive electrode active material precursor and the lithium source material, and additionally a doping source material if necessary, and then calcining them, and may include a plurality of nickel-based lithium metal oxide particles.

Accordingly, similar to the positive electrode active material precursor used as a source material, the positive electrode active material precursor 1) may have the CSG form in which the high concentration of nickel is constantly maintained in the core portion and the concentration of nickel is sharply reduced, and 2) the value of Formula 2 may be 50% or more, 60% or more, 70% or more, 75% or more, or 83% or more as in examples to be described below. In addition, the value of Formula 2 may be 97% or less. In this case, a length of the core portion may be controlled to be, e.g., 2.5 μm or more and less than 24.5 μm, or 2.5 μm or more and less than 16.5 μm. When the length of the core portion is less than 2.5 μm, an effect of improving a heat-generation amount is not exhibited, and when the length of the core portion is 24.5 μm or more, an initial resistance is greatly increased, and the performance of the lithium rechargeable battery using a positive electrode active material is greatly reduced. As such, when the value of Equation 2 is at least 50% or more, the heat generation amount of the positive electrode active material according to the present exemplary embodiment may be dramatically reduced, thereby remarkably improving the thermal stability.

In other words, the positive electrode active material of the present exemplary embodiment may have a heat generation amount of 650 J/g or less, more specifically 600 J/g or less, or 550 J/g or less, as measured by differential scanning calorimetry in a range of 210° C. to 230° C.

A detailed process will be described later, and a positive electrode active material including the nickel-based lithium metal hydroxide particles will now be described in detail.

Size and Gaussian Distribution of Nickel-Based Lithium Metal Oxide Particles

The nickel-based lithium metal oxide particles may be a plurality of particles having a D50 particle size in a Gaussian distribution within a range of 10 to 30 μm.

Specifically, the particles of the D50 may be classified into particles having a diameter of 10 μm or more and less than 13 μm, particles having a diameter of 13 μm or more and less than 14 μm, and particles having a diameter of 14 μm or more and less than 15 μm.

Further, the classified particles of the D50 may have a uniform composition for each diameter. Specifically, for example, a difference in Ni content between the nickel-based metal hydroxide particles may be 3% or less, more specifically 2.5% or less, or 2.0% or less. This is supported by a fact that, when the plurality of nickel-based lithium metal oxide particles are classified, a Gaussian distribution graph of each classified D50 particle size has a same tendency as a Gaussian distribution graph before being classified. A more concrete basis will be presented in evaluation examples described later.

Internal Composition of Nickel-Based Lithium Metal Oxide Particle

Specifically, an average composition of the classified particles of the D50 for each diameter may be represented by Chemical Formula 4:

Li₁₊ₘ[Ni_{1-w4-x4-y4}Co_{w4}M1ₓ₄M2_{y4}]_{1-z4}M3_{z4}O₂₋ₚ₄Xₚ₄ [Chemical Formula 4]

wherein, in Chemical Formula 4, each of M1, M2, and M3 is one element selected from the group consisting of Mn, Al, Mg, Zr, Sn, Ca, Ge, Ga, B, Ti, Mo, Nb, and W, X is one element selected from the group consisting of F, N, and P, each of w4, x4, y4, z4, and p4 satisfies a following corresponding inequality: 0<w4≤0.2, 0<x4≤0.2, 0≤y4≤0.1, 0≤z4≤0.1, 0<w4+x4+y4+z4≤0.4, and 0≤p4≤0.1, and m satisfies an inequality: −0.05≤m≤0.25.

An average molar content of nickel of 60% or more for each of the D50 particle sizes that are classified indicates a high concentration.

For example, in Formula 4, M1 may indicate Mn, and each of w4, x4, y4, z4, and p4 may satisfy a following corresponding inequality: 0<w4≤0.1, 0<x4≤0.1, y4=z4=p2=0, and 0<w4+x4+y4+z4≤0.2.

In the present exemplary embodiment, the M3 may be, e.g., Zr. When M3 is Zr, z4 may satisfy 0≤z4≤0.01 or 0≤z4≤0.008. When a molar ratio of Zr in a total particle composition satisfies the above range, the capacity and lifetime characteristic of the lithium rechargeable battery may be improved, and an initial resistance and a resistance increasing rate may be remarkably improved. In addition, a heat generation onset temperature and peak temperature characteristic depending on DSC measurement are excellent.

Specifically, a composition of the core portion in the nickel-based lithium metal oxide particle may be represented by Chemical Formula 5 in an entire region:

Li₁₊ₘ[Ni_{1-w5-x5-y5}Co_{w5}M1ₓ₅M2_{y5}]_{1-z5}M3_{z5}O₂₋ₚ₅Xₚ₅ [Chemical Formula 5]

wherein, in Chemical Formula 5, each of M1, M2, and M3 is one element selected from the group consisting of Mn, Al, Mg, Zr, Sn, Ca, Ge, Ga, B, Ti, Mo, Nb, and W, X is one element selected from the group consisting of F, N, and P, each of w5, x5, y5, z5, and p5 satisfies a following corresponding inequality: 0≤w5≤0.1, 0≤x5≤0.1, 0≤y5≤0.1, 0≤z5≤0.1, 0≤w5+x5+y5+z5≤0.2, and 0≤p5≤0.1, and m satisfies an inequality: −0.05≤m≤0.25.

This indicates that the molar content of nickel in the entire region of the core portion in the nickel-based lithium metal oxide particle is 80% or more, which is higher than the average composition.

For example, in Formula 5, M1 may indicate Mn, and each of w5, x5, y5, z5, and p5 may satisfy a following corresponding inequality: 0<w5≤0.05, 0<x5≤0.05, y5=z5=p2=0, and 0<w5+x5+y5+z5≤0.1.

In addition, a composition of the shell portion in the nickel-based lithium metal oxide particle may be represented by Formula 5 at the interface, and is represented by Formula 6 at the outermost portion, wherein molar contents of nickel (Ni), M1, M2, and M3 gradually change from the interface to the outermost portion:

Li₁₊ₘ[Ni_{1-w6-x6-y6}Co_{w6}M1ₓ₆M2_{y6}]_{1-z6}M3_{z6}O₂₋ₚ₆Xₚ₆ [Chemical Formula 6]

wherein, in Chemical Formula 6, each of M1, M2, and M3 is one element selected from the group consisting of Mn, Al, Mg, Zr, Sn, Ca, Ge, Ga, B, Ti, Mo, Nb, and W, X is one element selected from the group consisting of F, N, and P, each of w6, x6, y6, z6, and p6 may satisfy a following corresponding inequality: 0<w6≤0.3, 0<x6≤0.3, 0≤y6≤0.1, 0<z6≤0.1, 0<w6+x6+y6+z6≤0.5, and 0≤p6≤0.1, and m satisfies an inequality: −0.05≤m≤0.25.

This indicates that the molar content of nickel is 80% or more at the interface with the core portion and is 60% or more in the outermost portion in the nickel-based lithium metal oxide particle, and having a concentration gradient in which the molar content of nickel gradually decreases from the interface to the outermost portion. In addition, the metals (i.e., M1, M2, and M3) other than nickel have a concentration gradient in which the molar content gradually increases from the interface to the outermost portion. For example, in Formula 6, M1 may indicate Mn, and each of w6, x6, y6, z6, and p6 may satisfy a following corresponding inequality: 0<w6≤0.25, 0<x6≤0.25, y6=z6=p2=0, and 0<w6+x6+y6+z6≤0.5.

The nickel-based lithium metal oxide particle may have a stable structure according to a composition of the shell portion of Formula 6 while accomplishing a high capacity according to a total composition of Formula 4 and a composition of the core portion of Formula 5.

In the present exemplary embodiment, the nickel metal oxide particle has an angle formed by a curve representing the nickel molar content of the core portion and a curve representing the nickel molar content of the shell portion that is in the range of 95.1° to 141.3° or 95.1° to 126.3°. That is, when the angle formed by the curve representing the nickel molar content of the core portion and the curve representing the nickel molar content of the shell portion satisfies the above range, the metal elements in the positive electrode active material particles may exist at a uniform concentration, thereby remarkably improving the charge/discharge characteristic, the cycle-life characteristic, the thermal stability, and the resistance characteristic of the lithium rechargeable battery.

Coating Layer

Meanwhile, the positive electrode active material may further include a coating layer surrounding an outer surface of the shell portion. In this case, the coating layer may include at least one of, e.g., an element of B, Mg, Zr, Al, Mn, Co, or a combination thereof; an oxide of the element; an amorphous compound thereof; a lithium ion conductive oxide thereof (e.g., lithium borate or lithium borosilicate); and a polymer thereof.

In the present exemplary embodiment, a material contained in the coating layer may be B. In this case, the B may be coated on the surface of the nickel-based metal hydroxide particle in a range of 200 ppm to 2000 ppm or 400 ppm to 1200 ppm. When B is coated on the particle surface in the above range, this is very advantageous in that the initial capacity of the lithium rechargeable battery may be improved and a cycle characteristic may be remarkably improved.

In this case, a material included in the coating layer may suppress direct contact between the nickel-based lithium metal oxide particles with the electrolyte, and a side reaction thereof.

### Preparation Method of Positive Electrode Active Material

An exemplary embodiment of the present invention provides a preparation method of a positive electrode active material for a lithium rechargeable battery, including: a preparation step of a first metal salt aqueous solution and a second metal salt aqueous solution, each of which contains a nickel source material, a dissimilar metal source material, and water, wherein molar concentrations of the nickel source material are different in the first metal salt aqueous solution and the second metal salt aqueous solution; a first co-precipitation step of forming a core portion by supplying the first metal salt aqueous solution to a reactor having a pH that is constantly maintained, to which a chelating agent is supplied; and a second co-precipitation step of forming a shell portion surrounding an outer surface of the core portion by gradually decreasing a supply rate of the first metal salt aqueous solution and by gradually increasing a supply rate of the second metal salt aqueous solution, after the first co-precipitation step, wherein a nickel-based metal hydroxide particle including the core portion and the shell portion can be provided in the second co-precipitation step, and the first co-precipitation step and the second co-precipitation step are controlled to obtain a value of 12.5% or more of Formula 2, and an obtaining step of a nickel-based lithium metal oxide particle by calcining a mixture of the nickel-based metal hydroxide particle and a lithium source material, after the second co-precipitation step:

log T1/log(T1+T2)≈R1/(R1+D1) [Formula 2]

wherein, in Formula 2, T1 is an execution time of the first co-precipitation step, and T2 is an execution time of the second co-precipitation step.

According to the exemplary embodiment of the present invention, the preparation method of the positive electrode active material includes a series of steps of mixing the positive electrode active material precursor and the lithium source material, and additionally a doping source material if necessary, and then calcining them, as described above. Herein, a preparation method of the positive electrode active material precursor is the same as that described above.

Hereinafter, only steps after the second co-precipitation step will be described in order to exclude the description overlapping with that described above.

Calcining Step (Obtaining Step of Nickel-Based Lithium Metal Oxide Particle)

A nickel-based lithium metal oxide particle is obtained by calcining a mixture of the nickel-based metal hydroxide particle and a lithium source material, after the second co-precipitation step.

In this case, as mentioned above, a doping source material may be added to the mixture, and the resultant nickel-based lithium metal oxide particle may include a dopant.

A calcining temperature may be in range of 700 to 800° C., and a calcining time may be 12 to 20 hours, which is generally known.

Coating Layer Formation Step

The preparation method may further include a forming step of a coating layer surrounding an outer surface of the nickel-based lithium metal oxide particle after the obtaining step of the nickel-based lithium metal oxide particle.

Specifically, the forming step of the coating layer surrounding the outer surface of the nickel-based lithium metal oxide particle may include: a mixing step of the nickel-based lithium metal oxide particle and a coating source material; and a heat-treating step of a mixture of the nickel-based lithium metal oxide particle and a coating source material.

The coating source material may be a source material such as an element of B, Mg, Zr, Al, Mn, Co, or a combination thereof; an oxide of the element; an amorphous compound thereof; a lithium ion conductive oxide thereof (e.g., lithium borate or lithium borosilicate); and a polymer thereof. The step of mixing the nickel-based lithium metal oxide particle and the coating source material is not limited to dry mixing or wet mixing.

### Lithium Rechargeable Battery

An exemplary embodiment of the present invention provides a lithium rechargeable battery including: a positive electrode; a negative electrode; and an electrolyte.

This corresponds to a lithium rechargeable battery which exhibits excellent performance by including the above-described positive electrode active material, and the positive electrode active material has already been described in detail, so a detailed description will be omitted.

In addition, a configuration of a lithium rechargeable battery excluding the electrode positive active material is generally known.

Hereinafter, preferred examples and experimental examples of the present invention will be described. However, the following examples are only exemplary embodiments of the present invention, and the present invention is not limited thereto.

### Example 1 (75% of Radius of Core Portion, Zr Doping, B Coating)

### (1) Preparation of Positive Electrode Active Material Precursor

1) Preparation of Metal Salt Solution

First, two metal salt aqueous solutions having different Ni, Co, and Mn concentrations were prepared by using NiSO₄.6H₂O as a nickel source material, CoSO₄.7H₂O as a cobalt source material, and MnSO₄.H₂O as a manganese source material.

A first metal salt aqueous solution for forming the core portion was prepared by mixing the source materials to satisfy a stoichiometric mole ratio of (Ni_{0.98}Co_{0.01}Mn_{0.01})(OH)₂ in distilled water such that an entire molar concentration of the metal salt reached 2.5 M.

Independently, a second metal salt aqueous solution for forming the shell portion was prepared by mixing the source materials to satisfy a stoichiometric mole ratio of (Ni_{0.64}Co_{0.23}Mn_{0.13})(OH)₂ in distilled water such that an entire molar concentration of the metal salt reached 2.5 M.

2) Co-Precipitation Process

A co-precipitation reactor in which two metal salt aqueous solution supply tanks are connected in series was prepared, and the first metal salt aqueous solution and the second metal salt aqueous solution were charged into the respective metal salt aqueous solution supply tanks.

Three liters of distilled water was placed in the co-precipitation reactor (capacity of 20 L, output of a rotary motor of 200 W), nitrogen gas was supplied at a rate of 2 L/min to remove dissolved oxygen, and it was agitated at 140 rpm while maintaining a temperature of the reactor at 50° C.

In addition, NH₄(OH) of a 14 M concentration as a chelating agent and a NaOH solution of an 8 M concentration as a controlling agent were continuously injected at 0.06 L/hour and 0.1 l/hour, respectively, while they were appropriately controlled to maintain a pH inside the reactor at 12 during the process.

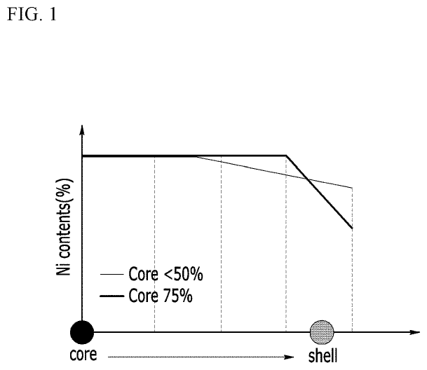

As such, in a reactor having a pH that is constantly maintained, to which a chelating agent is supplied, a dosing time and amount of each metal salt solution were controlled from the two metal salt aqueous solution supply tanks connected in series such that the radius of the core portion becomes 75% (refer to FIG. 1) based on radii of the core portion and the shell portion.

Specifically, the co-precipitation reaction was performed until a diameter of the precipitate became about 11.1 μm by adjusting an impeller speed of the reactor to 140 rpm while injecting the first metal salt aqueous solution at 0.4 L/hour. In this case, an average residence time of the solution in the reactor was adjusted to about 10 hours by adjusting a flow rate, and a co-precipitation compound having a slightly higher density was obtained by giving a steady state duration to the reactant after the reaction reached the steady state.

Subsequently, a total supplied solution was injected at 0.4 L/hour by varying a mixing ratio of the first metal salt aqueous solution and the second metal salt solution, to gradually decrease a supply rate of the first metal salt solution at 0.05 L/hour and to gradually increase a supply rate of the second metal salt solution at 0.35 L/hour. In addition, the average residence time of the solution in the reactor was adjusted to 20 hours or less by controlling the flow rate, and finally the co-precipitation reaction was performed until the diameter of the precipitate became 14.8 μm. In this case, an angle formed by curves representing the nickel molar contents of the core and shell portions was 126.3°.

3) Post-Treatment Process

The precipitate obtained according to the series of co-precipitation steps was filtrated, washed with water, and then dried in an oven at 100° C. for 24 hours to obtain a plurality of particles having an entire composition of (Ni0.88Co0.095Mn0.025)(OH)₂ as the positive electrode active material precursor of Example 1.

### (2) Preparation of Positive Electrode Active Material

The positive electrode active material precursor obtained in Example 1 and a lithium salt LiOH.H₂O (Samchun Chemical Co., Ltd., battery grade) was mixed at a molar ratio of 1:1.05 (precursor:lithium salt), and the mixture was charged into a tube furnace (inner diameter: 50 mm, length: 1000 mm) and calcined while introducing oxygen at 200 mL/min.

In this case, the calcining condition was maintained at 480° C. for 5 h and then was maintained at 750° C. for 16 h, and a temperature rise speed was 5° C./min. In addition, ZrO₂ powder as a doping material was mixed therewith to uniformly distribute Zr inside the particles during the calcining. Next, after the calcining, H₃BO₃ was dry-mixed therewith and then was subjected to heat treatment so as to allow B to be uniformly coated on the particle surface.

Finally, the positive electrode active material of Example 1 was prepared by using a plurality of particles having surfaces coated with B at 800 ppm, and an entire composition of the particles was Li_{1.05}(Ni_{0.88}Co_{0.095}Mn_{0.025})_{0.996}Zr_{(0.004)}O₂.

### Example 2 (75% of Radius of Core Portion, Zr Doping, No Coating)

### (1) Preparation of Positive Electrode Active Material Precursor

A positive active material precursor was prepared in a same manner as in Example 1.

### (2) Preparation of Positive Electrode Active Material

The positive electrode active material precursor obtained in Example 1 and a lithium salt LiOH.H₂O (Samchun Chemical Co., Ltd., battery grade) was mixed at a molar ratio of 1:1.05 (precursor:lithium salt), and the mixture was charged into a tube furnace (inner diameter: 50 mm, length: 1000 mm) and calcined while introducing oxygen at 200 mL/min.

In this case, the calcining condition was maintained at 480° C. for 5 h and then was maintained at 750° C. for 16 h, and a temperature rise speed was 5° C./min. In addition, ZrO₂ powder as a doping material was mixed therewith to uniformly distribute Zr inside the particles during the calcining.

Finally, the positive electrode active material of Example 2 was prepared by using a plurality of particles having an entire composition that was Li_{1.05}(Ni_{0.88}Co_{0.095}Mn_{0.025})_{0.996}Zr_{(0.004)}O₂.

### Examples 3 to 5 (75% of Radius of Core Portion, Zr Doping, No Coating)

A positive electrode active material of Examples 3 to 5 was prepared by mixing ZrO₂ powder as a doping material therewith such that a molar ratio of Zr in the entire particles was as shown in Table 1 below.

### Comparative Example 1 (Less than 50% of Radius of Core Portion, Zr Doping, B Coating)

### (1) Preparation of Positive Electrode Active Material Precursor

1) Preparation of Metal Salt Solution

The first metal salt aqueous solution for forming the core portion and the second metal salt aqueous solution for forming the shell portion were the same as those used in Example 1.

2) Co-Precipitation Process

In a same co-precipitation reactor as in Example 1, a dosing time and amount of each metal salt solution were controlled from the two metal salt aqueous solution supply tanks connected in series such that the radius of the core portion becomes less than 50% (refer to FIG. 1) based on radii of the core portion and the shell portion.

Specifically, the co-precipitation reaction was performed until a diameter of the precipitate became about 6.5 μm by adjusting an impeller speed of the reactor to 140 rpm while injecting the first metal salt aqueous solution at 0.4 L/hour. In this case, an average residence time of the solution in the reactor was adjusted to about 5 hours by adjusting a flow rate, and a co-precipitation compound having a slightly higher density was obtained by giving a steady state duration to the reactant after the reaction reached the steady state.

Subsequently, a total supplied solution was injected at 0.4 L/hour by varying a mixing ratio of the first metal salt aqueous solution and the second metal salt solution, to gradually decrease a supply rate of the first metal salt solution at 0.15 L/hour and to gradually increase a supply rate of the second metal salt solution at 0.25 L/hour. In addition, the average residence time of the solution in the reactor was adjusted to 20 hours or less by controlling the flow rate, and finally the co-precipitation reaction was performed until the diameter of the precipitate became 13.5 μm. In this case, an angle formed by curves representing the nickel molar contents of the core and shell portions was 145.70.

3) Post-Treatment Step

The precipitate obtained according to the series of co-precipitation steps was post-treated in the same manner as in Example 1 to obtain a plurality of particles having an entire composition of (Ni_{0.88}Co_{0.095}Mn_{0.025})(OH)₂ as the positive electrode active material precursor of Comparative Example 1.

### (2) Preparation of Positive Electrode Active Material

The active material precursor was subjected into the same steps as those of Example 2 to obtain a plurality of particles having surfaces coated with B at 800 ppm as an active material of Comparative Example 2, and a composition of the entire particles was Li_{1.05}(Ni_{0.88}Co_{0.095}Mn_{0.025})_{0.996}Zr_{(0.004)}O₂.

### Comparative Example 2 (Less than 50% of Radius of Core Portion, Zr Doping, No Coating)

### (1) Preparation of Positive Electrode Active Material Precursor

A positive active material precursor was prepared in a same manner as in Comparative Example 1.

### (2) Preparation of Positive Electrode Active Material

The positive electrode active material precursor obtained in Example 1 and a lithium salt LiOH.H₂O (Samchun Chemical Co., Ltd., battery grade) was mixed at a molar ratio of 1:1.05 (precursor:lithium salt), and the mixture was charged into a tube furnace (inner diameter: 50 mm, length: 1000 mm) and calcined while introducing oxygen at 200 mL/min.

In this case, the calcining condition was maintained at 480° C. for 5 h and then was maintained at 750° C. for 16 h, and a temperature rise speed was 5° C./min. In addition, ZrO₂ powder as a doping material was mixed therewith to uniformly distribute Zr inside the particles during the calcining.

Finally, the positive electrode active material of Comparative Example 2 was prepared by using a plurality of particles having an entire composition that was Li_{1.05}(Ni_{0.88}Co_{0.095}Mn_{0.025})_{0.996}Zr_{(0.004)}O₂.

### Comparative Example 3 (75% of Radius of Core Portion, No Doping and No Coating)

A positive electrode active material was prepared such that an entire composition of the particles was Li_{1.05}Ni_{0.88}Co_{0.095}Mn_{0.025}O₂ in a same manner as in Example 2 except that ZrO₂ powder as a doping material was not mixed.

### Reference Example 1

(1) Preparation of Positive Electrode Active Material Precursor

A metal salt solution was prepared in the same manner as in Example 1, and then a positive electrode active material precursor was prepared in the same manner as in Example 1 except that the co-precipitation process was performed such that the angle formed by curves representing the nickel molar contents of the core and shell portions was 158.19°. In this case, the Ni content of the core portion was designed to be 94% and the Ni content of the shell portion was designed to be 84%.

Accordingly, a plurality of particles having an entire composition of (Ni_{0.88}Co_{0.095}Mn_{0.025})(OH)₂ as the active material precursor of Reference Example 1 were obtained.

(2) Preparation of Positive Electrode Active Material

A positive electrode active material was prepared by a same method as in Example 1 by using the positive electrode material precursor obtained in the above step (1).

Finally, the positive electrode active material of Reference Example 1 was prepared by using a plurality of particles having an entire composition that was Li_{1.05}(Ni_{0.88}Co_{0.095}Mn_{0.025})_{0.996}Zr_{(0.004)}O₂.

TABLE 1

| | Radius of core | |
|---|---|---|
| | portion | |
| | (Radius of | |
| | core portion + | |
| | radius of shell | |
| | portion)* | |
| Division | 100% | Particle composition |
| Example 1 | Core 75% | B is coated on surfaces of particles of |
| | | Li_{1.05}(Ni_{0.88}Co_{0.095}Mn_{0.025})_{0.996}Zr_{0.004}O₂ at 800 ppm |
| Example 2 | Core 75% | Li_{1.05} (Ni_{0.88}Co_{0.095}Mn_{0.025})_{0.996}Zr_{0.004}O₂ |
| Example 3 | Core 75% | Li_{1.05} (Ni_{0.88}Co_{0.095}Mn_{0.025})_{0.997}Zr_{0.003}O₂ |
| Example 4 | Core 75% | Li_{1.05} (Ni_{0.88}Co_{0.095}Mn_{0.025})_{0.998}Zr_{0.002}O₂ |
| Example 5 | Core 75% | Li_{1.05} (Ni_{0.88}Co_{0.095}Mn_{0.025})_{0.995}Zr_{0.005}O₂ |
| Comparative | Core <50% | B is coated on surfaces of particles of |
| Example 1 | | Li1.05(Ni0.88Co0.095Mn0.025)0.996Zr0.004O2 at |
| | | 800 ppm |
| Comparative | Core <50% | Li_{1.05} (Ni_{0.88}Co_{0.095}Mn_{0.025})_{0.996}Zr_{0.004}O₂ |
| Example 2 | | |
| Comparative | Core 75% | Li_{1.05}Ni_{0.88}Co_{0.095}Mn_{0.025}O₂ |
| Example 3 | | |
| Reference | Core 75% | Li_{1.05} (Ni_{0.88}Co_{0.095}Mn_{0.025})_{0.996}Zr_{0.004}O₂ |
| Example 1 | | |

*An angle formed by curves representing the nickel molar contents of the core and shell portions was 126.3° of Example 1, an angle formed by curves representing the nickel molar contents of the core and shell portions was 145.7° of comparative Example 1, and an angle formed by curves representing the nickel molar contents of the core and shell portions was 158.1° of Example 1.

### Evaluation Example 1 (Distribution Analysis of Particle Diameter of Positive Electrode Active Material)

1 kg of each of positive electrode active materials of Examples 1 to 5 and Comparative Examples 1 to 3 were well dispersed in 2 kg of ethanol (99.9%), and then a supernatant containing a large amount of relatively small-diameter particles was separated by a difference in weight per particle diameter, and classified by D50 particle size.

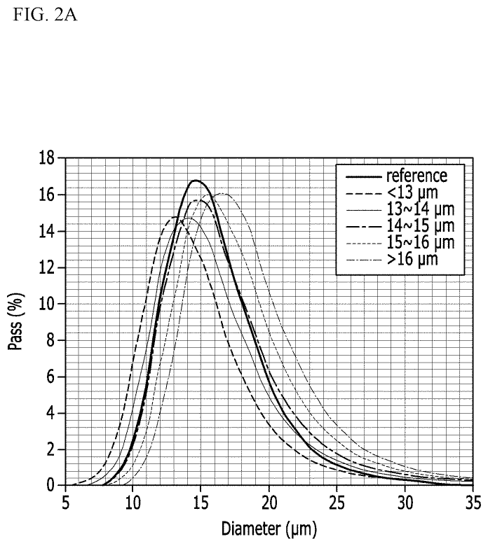

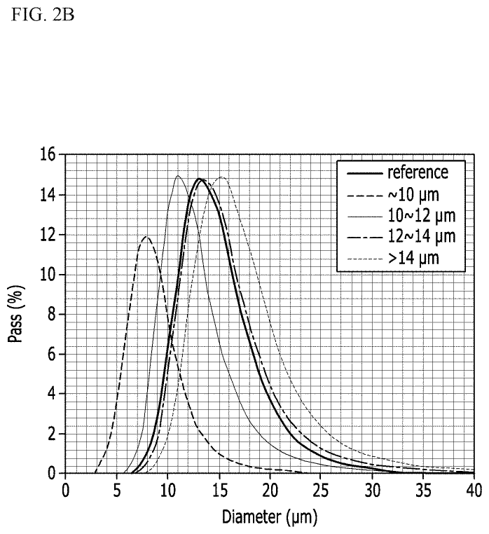

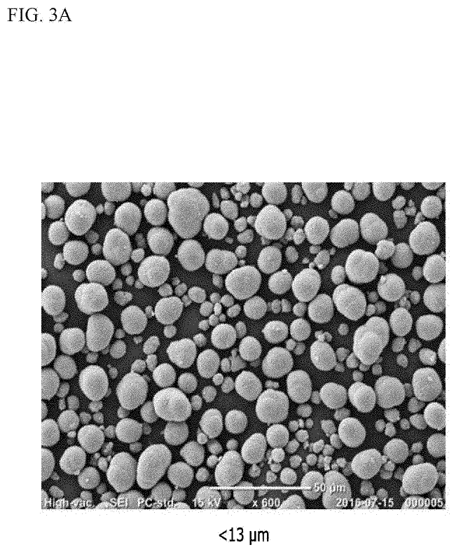

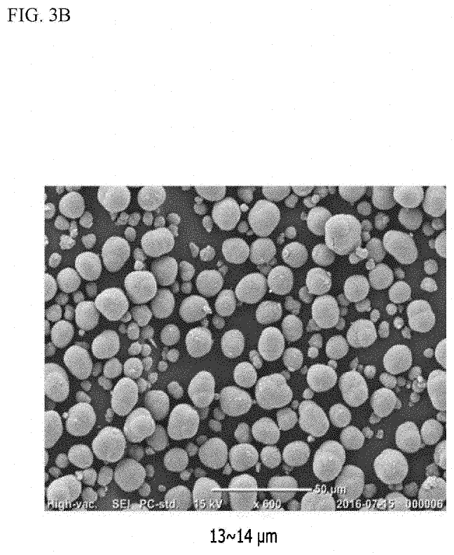

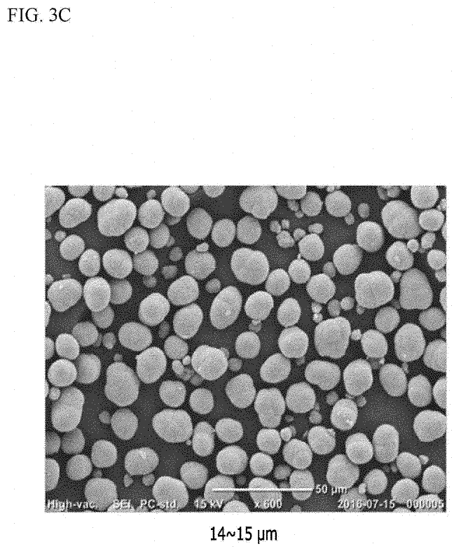

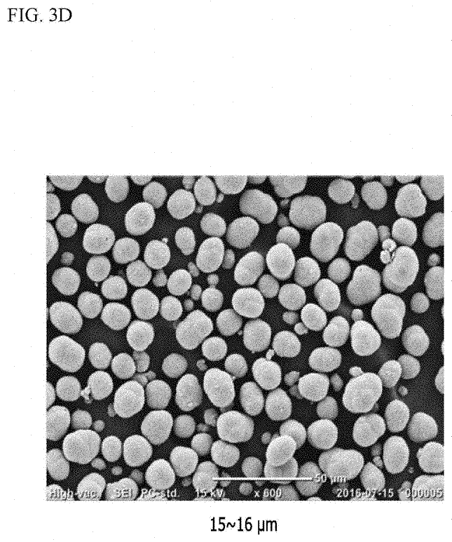

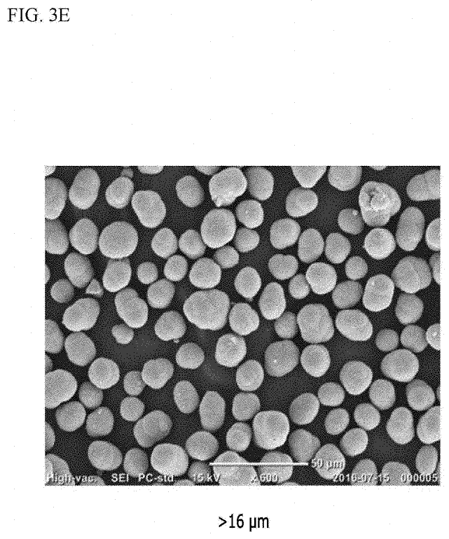

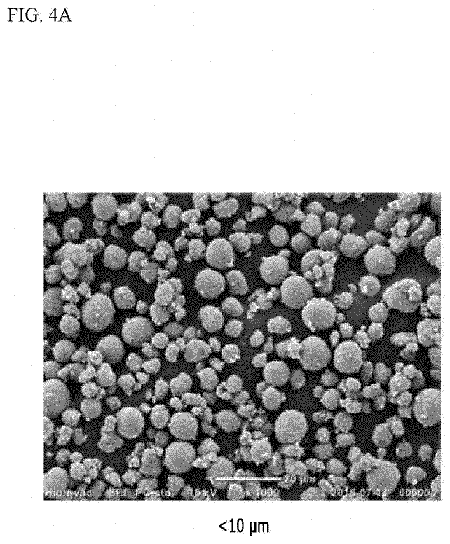

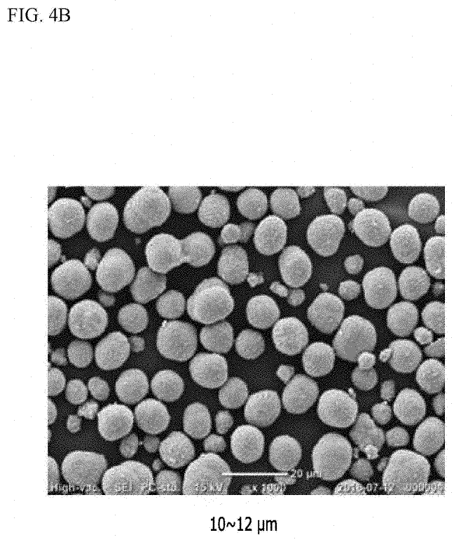

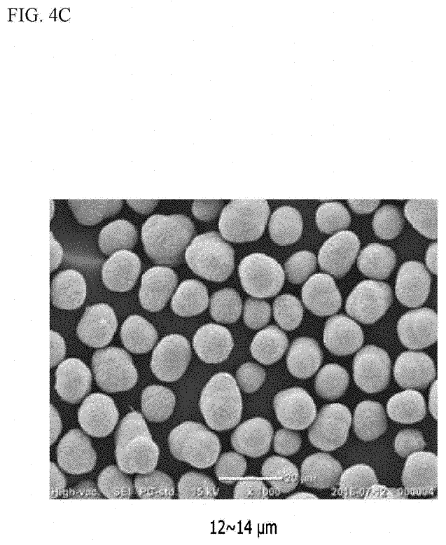

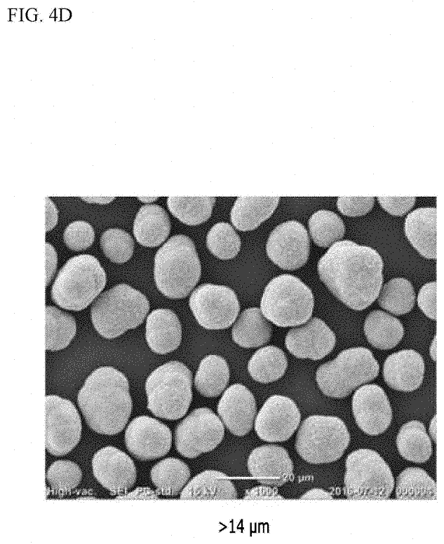

FIG. 2A and FIG. 2B respectively illustrate particle size analysis (PSA) results for each positive electrode active material in Example 1 and Comparative Example 1. FIG. 3A to FIG. 3E illustrate SEM photographs of diameters classified in Example 1, and FIG. 4A to FIG. 4D illustrate SEM photographs of diameters classified in Comparative Example 1.

According to FIG. 2A and FIG. 3A to FIG. 3E, it can be seen that D50 particles of the positive electrode active material of Example 1 are classified into particles with a diameter of 10 μm or more and less than 13 μm (FIG. 3A), 13 μm or more and less than 14 μm (FIG. 3B), 14 μm or more and less than 15 μm (FIG. 3C), 15 μm or more and less than 16 μm (FIG. 3D), and 16 μm or more and less than 30 μm (FIG. 3E), showing a Gaussian distribution for each particle diameter. In this case, it can be seen that the Gaussian distribution represented by each particle diameter in Example 1 has the same tendency as the unclassified particles (indicated by reference).

On the other hand, according to FIG. 2B and FIG. 4A to FIG. 4D, it can be seen that D50 particles of the positive electrode active material of Comparative Example 1 are classified into particles with a diameter of less than 10 μm (FIG. 4A), 10 μm or more and less than 12 μm (FIG. 4B), 12 μm or more and less than 14 μm (FIG. 4C), and 14 μm or more and less than 30 μm (FIG. 4D), showing a Gaussian distribution for each particle diameter. However, it can be seen that the Gaussian distribution represented by each particle diameter in Comparative Example 1 has a tendency that is different from the unclassified particles (indicated by reference).

### Evaluation Example 2 (Analysis of Internal Composition for Each Particle Diameter of Positive Electrode Active Material)

ICP measurement results for each of the positive electrode active materials of Example 1 and Comparative Example 1 are reported in Tables 2 and 3 below.

TABLE 2

| | | Before | | | | | | Maximum |
|---|---|---|---|---|---|---|---|---|
| | | classified | After classified (μm) | | | | | composition |
| | | (μm) | (In parentheses, D50) | | | | | difference |
| | | 14.21 | <13 | 13-14 | 14-15 | 15-16 | >16 | (Cₘₐₓ − |
| Example 1 | | 14.21 | 12.76 | 13.71 | 14.47 | 15.31 | 16.22 | Cₘᵢₙ) |
| Ni % | mol % | 88.43 | 87.56 | 87.97 | 88.47 | 88.94 | 89.27 | 1.71 |
| Co % | mol % | 9.35 | 10.04 | 9.71 | 9.32 | 8.94 | 8.7 | 1.34 |
| Mn % | mol % | 2.22 | 2.4 | 2.32 | 2.21 | 2.12 | 2.03 | 0.37 |
| Zr | ppm | 2121 | 2622 | 2462 | 2101 | 1878 | 1780 | 842 |
| B | ppm | 777 | 480 | 521 | 471 | 442 | 447 | 335 |

TABLE 3

| | | Before | | | | | Maximum |
|---|---|---|---|---|---|---|---|
| | | classified | After classified (μm) | | | | composition |
| | | (μm) | (In parentheses, D50) | | | | difference |
| Comparative | | 12.97 | <10 | 10-12 | 12-14 | >14 | (Cₘₐₓ − |
| Example 1 | | 12.97 | 7.45 | 11.00 | 13.42 | 14.93 | Cₘᵢₙ) |
| Ni | mol % | 88.30 | 87.0 | 87.56 | 89.3 | 90.30 | 3.30 |
| Co | mol % | 9.20 | 10.10 | 9.85 | 8.97 | 8.7 | 1.40 |
| Mn | mol % | 2.50 | 2.52 | 2.47 | 2.44 | 2.42 | 1.0 |
| Zr | ppm | 4400 | 17,870 | 5839 | 3247 | 2959 | 14,911 |
| B | ppm | 610 | 550 | 0 | 0 | 0 | 610 |

Referring to Table 3, in the case of Comparative Example 1, a maximum composition difference (Cmax−Cmin) is 3.3%, which is a relatively high value, and a composition differences between Co and Mn are 1.4 to 1.0%, which is a relatively high value. In addition, composition differences of Zr and B are about 14,911 ppm and 610 ppm, respectively, which are very high.

In addition, Zr, which is a dopant in Comparative Example 1, was found to be 4 times or more larger than the initial design value in particles having a diameter of less than 10 μm, and an amount of doping was decreased as the particle diameter was increased. The B coating was present only in particles with a diameter of less than 10 μm, but not in particles with a diameter of 10 μm or more.

Referring to Table 2, in the case of Example 2, the maximum composition difference of Ni is 1.71%, which is half of that of Comparative Example 2, and the composition difference between Co and Mn is relatively small. In addition, the composition difference of Zr and B is about 842 ppm and 335 ppm, respectively, which shows a half composition difference compared with Comparative Example 1. This is because the radius of the core portion was controlled to 75% of the particle radius.

In addition, in Example 1, it can be seen that Zr and B are uniformly present regardless of the diameter of the particle. However, a decrease in Zr and B by a small amount compared to an initial design value is due to partial dissolution of ethanol in the classification.

On the other hand, for the positive electrode active material of Example 2, the content of Zr was measured at each radius from the center of the core portion in a shell direction using each particle before and after classification.

TABLE 4

| | | The content of Zr (at %) at each radius from the center | | | | | | |
|---|---|---|---|---|---|---|---|---|
| | | of the core portion to the shell direction. | | | | | | |
| Example 2 | | 1 μm | 2 μm | 3 μm | 4 μm | 5 μm | 6 μm | 7 μm |
| Before classified (μm) | 14.21 | 0.233 | 0.233 | 0.233 | 0.233 | 0.235 | 0.236 | 0.237 |
| After classified (μm) | <13 | 0.290 | 0.290 | 0.291 | 0.290 | 0.291 | 0.292 | 0.293 |
| (In parentheses, D50) | 12.76 | | | | | | | |
| | 13-14 | 0.273 | 0.273 | 0.273 | 0.273 | 0.274 | 0.274 | 0.275 |
| | 13.71 | | | | | | | |
| | 14~15 | 0.231 | 0.231 | 0.231 | 0.232 | 0.233 | 0.234 | 0.236 |
| | (14.47) | | | | | | | |
| | 15~16 | 0.207 | 0.207 | 0.208 | 0.208 | 0.209 | 0.210 | 0.211 |
| | (15.31) | | | | | | | |
| | >16 | 0.197 | 0.197 | 0.197 | 0.198 | 0.198 | 0.198 | 0.198 |
| | 16.22 | | | | | | | |

Referring to Table 4, it can be seen that the Zr content of the positive electrode active material prepared depending on Example 2 is constant in each radius from the center of the core portion in the shell direction before and after classification. That is, in the positive electrode active material prepared in Example 2, the doping element is uniformly present in the particles, and thus it can be seen that the cathode active material of Example 2 is a positive electrode active material that is uniformly doped with Zr, not coated.

### Evaluation Example 3 (Charging/Discharging Capacity Analysis of Cell for Each Particle Diameter of Positive Electrode Active Material)

Cells were manufactured by applying each positive electrode active material before and after the classification in Evaluation Example 2, and the charge and discharge capacity analysis results of each case are recorded in the following Table 5.

To this end, PVDF (polyvinylidene fluoride) as a binder and DENKA BLACK (commercial name: Super P) as a conductive material were mixed in a ratio of 94:3:3 (active material:binder:conductive material), followed by coating with an aluminum current collector, and then followed by drying and roll pressing to form an electrode.

Lithium metal (Li-metal) was used as a counter electrode, and an electrolyte solution obtained by dissolving a solution of 1 mol of LiPF₆ in a mixed solvent of ethylene carbonate (EC):dimethyl carbonate (DMC) in a volume ratio of 1:2 was used.

2032 half-coin cells were manufactured using the above-described constituent elements according to a usual manufacturing method.

Each cell was subjected to an initial charge (4.25 V) and a discharge (2.5 V) at room temperature of 25° C. under a constant current condition of 0.1 C, followed by a charge/discharge at 0.2 C, wherein charge capacity and discharge capacity are shown in Tables 3 and 4, respectively. In this case, when it reaches a charge end voltage, the charge end voltage is maintained, and when it reaches a current amount of 1/20 C, a mode is switched to a discharge mode.

Results of charging/discharging cycles under these conditions are shown in Tables 5. The results in Table 5 relate to the results in Tables 2 and 3.

TABLE 5

| | | Charge | Discharge | Initial |
|---|---|---|---|---|
| | | capacity | capacity | efficiency |
| Division | | (mAh/g) | (mAh/g) | (%) |
| Example 1 | Before classified | 236.63 | 215.20 | 90.94 |
| | (D50 14.21 μm) | | | |
| | <13 μm | 236.19 | 210.73 | 89.22 |
| | 13-14 μm | 236.79 | 213.05 | 89.97 |
| | 14-15 μm | 238.79 | 213.78 | 89.53 |
| | 15-16 μm | 239.35 | 214.07 | 89.44 |
| | >16 μm | 244.58 | 216.89 | 88.68 |
| Example 2 | Before classified | 232.99 | 211.14 | 90.62 |
| | (D50 14.21 μm) | | | |
| | <13 μm | 231.10 | 206.65 | 89.42 |
| | 13-14 μm | 233.21 | 209.12 | 89.67 |
| | 14-15 μm | 234.59 | 209.54 | 89.32 |
| | 15-16 μm | 234.48 | 210.14 | 89.62 |
| | >16 μm | 239.82 | 212.77 | 88.72 |
| Example 3 | Before classified | 232.24 | 210.89 | 90.53 |
| | (D50 14.15 μm) | | | |
| Example 4 | Before classified | 232.12 | 210.52 | 90.61 |
| | (D50 14.02 μm) | | | |
| Example 5 | Before classified | 231.81 | 209.21 | 90.25 |
| | (D50 14.35 μm) | | | |
| Comparative | Before classified | 238.20 | 214.70 | 90.13 |
| Example 1 | (D50 12.97 μm) | | | |
| | <10 μm | 226.58 | 203.45 | 89.79 |
| | 10-12 μm | 234.64 | 210.57 | 89.74 |
| | 12-14 μm | 242.94 | 216.68 | 89.19 |
| | >14 μm | 243.63 | 218.00 | 89.48 |
| Comparative | Before classified | 231.57 | 208.67 | 90.11 |
| Example 2 | (D50 12.97 μm) | | | |
| | <10 μm | 221.51 | 198.54 | 89.63 |
| | 10-12 μm | 228.58 | 204.45 | 89.44 |
| | 12-14 μm | 235.49 | 210.58 | 89.42 |
| | >14 μm | 237.16 | 211.98 | 89.38 |
| Comparative | Before classified | 235.65 | 207.51 | 88.01 |
| Example 3 | (D50 14.31 μm) | | | |
| Reference | Before classified | 233.17 | 209.34 | 89.78 |
| Example 1 | (D50 14.19 μm) | | | |

Referring to Table 5, it can be seen that a deviation between a charge capacity and a discharge capacity is large due to a Ni content difference for each diameter in the particles of Comparative Example 1 in which a length of the core portion is less than 50% even when doping and coating were performed. Particularly, in Comparative Example 1, the capacity of the cells was drastically reduced in the particles with a diameter of less than 10 μm, and this is because Zr, which is a dopant, was intensively included as shown in Table 3. Generally, Zr helps to improve thermal stability, while there is a disadvantage that capacity increases when an amount of doping increases.

On the other hand, in the particles of Example 1 in which the length of the core portion is 75%, when the particle diameter is less than 13 μm, the discharge capacity is 210.73 mAh/g at a minimum, and when the particle diameter is more than 16 μm, the maximum discharge capacity is 216.89 mAh/g, which shows that the deviation is very small.

In the meantime, it can be seen that a deviation between a charge capacity and a discharge capacity is large due to a Ni content difference for each diameter in the positive electrode active material of Comparative Example 2 in which the length of the core portion is less than 50% even when doping was performed. Particularly, the discharge capacity of the cells was greatly reduced in Comparative Example 2, which has the particle diameter of less than 10 μm.

In addition, the charge capacity was increased by 2.66 mAh/g, but the discharge capacity was decreased by 3.63 mAh/g, resulting in an initial charge and discharge efficiency of 88.01% for the positive electrode active material of Comparative Example 3 in which the radius of the core portion was 75% or more in the entire particle radius, but no doping was performed. This is because cation mixing is increased in a structure of the positive electrode material by not doping.

On the other hand, in the positive electrode active material of Example 2, in which the radius of the core portion was 75% or more in the entire particle radius, but the doping was performed without coating, when a D50 particle diameter is less than 13 μm, the discharge capacity is 206.65 mAh/g at a minimum, and when the D50 particle diameter is more than 16 μm, a maximum discharge capacity is 212.77 mAh/g, which shows that the deviation is very small.

It can be seen that an initial efficiency was improved by at least 0.14% or more in the positive electrode active material of Example 3 in which a mole ratio of zirconium was adjusted to 0.003 mol in the entire particles, Example 4 in which it was adjusted to 0.002 mol, and Example 5 in which it was adjusted to 0.005 mol, as compared with the positive electrode active material of Comparative Examples 1 to 3.

Next, it can be seen that the deviation between the charge capacity and the discharge capacity was reduced and the initial efficiency is slightly improved in the case of Reference Example 1 in which the length and particle composition of the core portion are the same as in Example 2 but differ only in the angle formed by the curves indicating the nickel molar contents of the core portion and the shell portion as compared with comparative Example 3.

### Evaluation Example 4 (Analysis of Cycle-Life Characteristic of Cell for Each Particle Diameter of Positive Electrode Active Material)

Cells were manufactured by applying each positive electrode active material before and after the classification in Evaluation Example 2, and the cycle-life analysis results of each case are recorded in the following Table 6.

Each cell was manufactured in the same manner as in Evaluation Example 3, and a charge and discharge cycle was performed 30 times at a constant charge rate of 0.3 C for each cell. Results of charging/discharging cycles at room temperature of 25° C. are shown in Table 6.

TABLE 6

| | | Initial | | |
|---|---|---|---|---|
| | | discharge | | |
| | | capacity | After 30 cycles | Cycle |
| | | (mAh/g) | (mAh/g) | efficiency |
| Division | | @0.3 C | @0.3 C | (%) |
| Example 1 | Before classified | 209.06 | 200.62 | 95.96 |
| | (D50 14.21 μm) | | | |
| | <13 | 205.07 | 195.36 | 95.26 |
| | 13-14 | 206.48 | 196.38 | 95.11 |
| | 14-15 | 206.44 | 195.76 | 94.83 |
| | 15-16 | 206.76 | 193.58 | 93.63 |
| Example 2 | Before classified | 209.27 | 197.63 | 94.44 |
| | (D50 14.21 μm) | | | |
| | <13 μm | 204.37 | 192.37 | 94.13 |
| | 13-14 μm | 207.21 | 196.04 | 94.61 |
| | 14-15 μm | 207.34 | 194.63 | 93.87 |
| | 15-16 μm | 208.13 | 192.23 | 92.36 |
| | >16 μm | 210.53 | 194.13 | 92.21 |
| Example 3 | Before classified | 208.74 | 197.07 | 94.41 |
| | (D50 14.15 μm) | | | |
| Example 4 | Before classified | 208.89 | 196.25 | 93.95 |
| | (D50 14.02 μm) | | | |
| Example 5 | Before classified | 207.11 | 195.62 | 94.45 |
| | (D50 14.35 μm) | | | |
| Comparative | Before classified | 208.82 | 198.84 | 95.22 |
| Example 1 | (D50 12.97 μm) | | | |
| | <10 μm | 197.55 | 192.30 | 97.34 |
| | 10-12 μm | 203.52 | 192.65 | 94.66 |
| | 12-14 μm | 210.23 | 191.16 | 90.93 |
| | >14 μm | 212.45 | 188.38 | 88.67 |
| Comparative | Before classified | 206.78 | 195.37 | 94.48 |
| Example 2 | (D50 12.97 μm) | | | |
| | <10 μm | 196.26 | 188.82 | 96.21 |
| | 10-12 μm | 202.37 | 190.13 | 93.95 |
| | 12-14 μm | 208.21 | 185.85 | 89.26 |
| | >14 μm | 209.51 | 183.80 | 87.73 |
| Comparative | Before classified | 205.36 | 148.17 | 72.15 |
| Example 3 | (D50 14.31 μm) | | | |
| Reference | Before classified | 207.31 | 192.52 | 92.86 |
| Example 1 | (D50 14.19 μm) | | | |

According to Table 6, in the case of Comparative Example 1, a deviation of the initial capacity for each particle diameter was significant, and in the case of a relatively small diameter, a retention ratio of the capacity after 30 cycles was high, whereas in the case of the diameter of less than 14 μm, a decrease in the capacity was significant.

On the other hand, the deviation of the initial discharge capacity for each particle diameter of Example 1 was relatively small, and a very good capacity retention rate was confirmed at 93 to 96% even after 30 cycles.

On the other hand, in the positive electrode active material of Comparative Example 2 in which the length of the core portion is less than 50% even when the doping was performed, a deviation of the initial capacity for each particle diameter was significant, and in the case of a relatively small diameter, a retention ratio of the capacity after 30 cycles was high, whereas in the case of the diameter of less than 14 μm, a decrease in the capacity was significant.

In addition, it can be seen that the cycle-life is drastically reduced to 72.15% of the initial capacity after 30 cycles for the positive electrode active material of Comparative Example 3 in which the length of the core portion is 75% or more, but the doping is performed. This is because the structure of the positive electrode active material is not stabilized when Zr-doping is not performed.

On the other hand, it can be seen that the deviation of the initial discharge capacity for each particle diameter is relatively small, and the capacity maintenance rate is in a range of 92 to 94%, which is very good, even after 30 cycles for the positive electrode active material of Example 2 in which the length of the core portion is 75%, and the doping is performed.

It can be seen that the capacity maintenance rate is 93.95% at the minimum and 94.45% at the maximum even after 30 cycles, which is very good as in Example 1, for the positive electrode active material of Example 3 in which a mole ratio of zirconium was adjusted to 0.003 mol in the entire particles, Example 4 in which it was adjusted to 0.002 mol, and Example 5 in which it was adjusted to 0.005 mol.

Next, it can be seen that the cycle efficiency is increased about 1.2 times as compared with Comparative Example 3 in the case of Reference Example 1 in which the length and particle composition of the core portion are the same as in Example 2 but differ only in the angle formed by the curves indicating the nickel molar contents of the core portion and the shell portion as compared with comparative Example 3.

### Evaluation Example 5 (DSC Thermal Analysis of Positive Electrode Active Material)

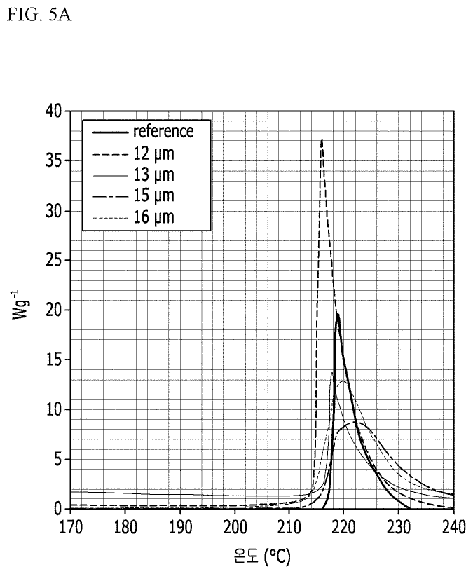

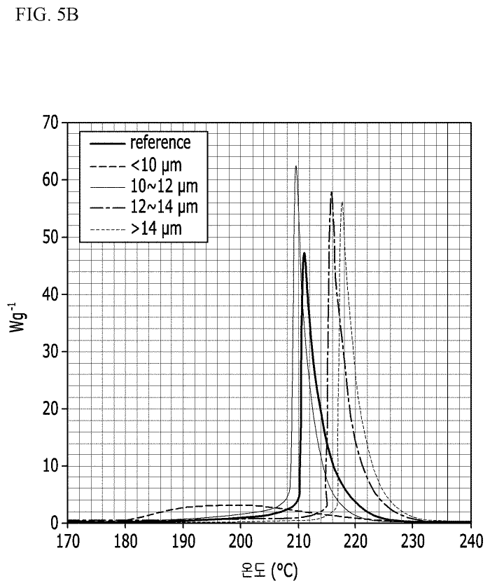

Thermal characteristics of the positive electrode active materials before and after the classification in Example 1, Example 2, and Comparative Examples 1 to 3 were measured with a differential scanning calorimeter (DSC), and results thereof are shown in Table 7 and FIG. 5A and FIG. 5B.

TABLE 7

| | | Heat | | |
|---|---|---|---|---|
| | | generation | | |
| | | onset | Peak | |
| | | temperature | temperature | Heat |
| | | (Onset | (Peak | generation |
| | | temperature) | temperature) | amount |
| Division | | (° C.) | (° C.) | (J/g) |
| Example 1 | Before classified | 216.1 | 219.4 | 495 |
| | (D50 14.21 μm) | | | |
| | 12 μm | 214.1 | 216.1 | 925 |
| | 13 μm | 215.3 | 219.2 | 437 |
| | 15 μm | 212.5 | 221.3 | 213 |
| | 16 μm | 212.5 | 220.4 | 350 |
| Example 2 | Before classified | 215.8 | 219.3 | 514 |
| | (D50 14.21 μm) | | | |
| | 12 μm | 213.9 | 216.1 | 947 |
| | 13 μm | 214.7 | 218.8 | 455 |
| | 15 μm | 212.1 | 220.1 | 230 |
| | 16 μm | 211.7 | 219.3 | 368 |
| | >16 μm | 212.1 | 219.7 | 363 |
| Example 3 | Before classified | 215.6 | 219.1 | 560 |
| | (D50 14.15 μm) | | | |
| Example 4 | Before classified | 215.1 | 218.9 | 610 |
| | (D50 14.02 μm) | | | |
| Example 5 | Before classified | 216.2 | 219.7 | 510 |
| | (D50 14.35 μm) | | | |
| Comparative | Before classified | 203.5 | 210.8 | 724.8 |
| Example 1 | (D50 12.97 μm) | | | |
| | <10 μm | 178.4 | 195.8 | 90.6 |
| | 10-12 μm | 205.3 | 209.3 | 936.2 |
| | 12-14 μm | 209.7 | 216.2 | 875.8 |
| | >14 μm | 210.5 | 217.5 | 845.6 |
| Comparative | Before classified | 201.8 | 219.3 | 744.3 |
| Example 2 | (D50 12.97 μm) | | | |
| | <10 μm | 177.7 | 194.3 | 90.1 |
| | 10-12 μm | 204.6 | 208.5 | 966.2 |
| | 12-14 μm | 208.9 | 215.8 | 921.3 |
| | >14 μm | 209.8 | 216.7 | 860.3 |
| Comparative | Before classified | 204.2 | 215.1 | 1,330 |
| Example 3 | (D50 14.31 μm) | | | |
| Reference | Before classified | 209.3 | 215.9 | 876.4 |
| Example 1 | (D50 14.19 μm) | | | |

Referring to Comparative Example 1 of FIG. 5B and FIG. 7, it can be seen that a peak temperature of the DSC varies relatively greatly depending on the particle diameters in Comparative Example 1. Particularly, the peak temperature of the particles having a diameter of less than 10 μm was significantly lowered to 195.8° C. as shown in Table 8, but an exothermic peak was extremely suppressed to 90.6 J/g. This is due to the fact that a doping amount of Zr contributing to improving the thermal stability is much higher than that of particles having different diameters. In addition, as the particle size of the classified particles was increased, both a heat generation onset temperature and the peak temperature gradually increased depending on a result of DSC measurement.

In addition, when the particle size increases, an average mol % of Ni increases as shown in Table 3, and thus an exothermic characteristic depending on the DSC measurement should be relatively decreased, but both the heat generation onset temperature and the peak temperature are increased. As a result, it can be expected that when the particle size is increased, a concentration gradient of a shell surface portion is more rapidly formed.

On the other hand, referring to Example 1 of FIG. 5A and Table 7, the measured peak temperature was almost uniform with no large difference according to the particle diameter in Example 1. Particularly, in Example 1, it can be seen that both the heat generation onset temperature and the peak temperature are high compared to each similar particle diameter. In particular, it should be noted that a heat generation amount of Example 1 is significantly reduced as compared with Comparative Example 1.

Therefore, from the DSC measurement result, it can be confirmed that Example 1 is significantly improved in thermal quality compared with Comparative Example 1.

Referring to Table 7, it can be seen that a peak temperature of the DSC varies relatively greatly depending on the particle diameters for the positive electrode active material of Comparative Example 2. Particularly, the peak temperature of the particles having a diameter of less than 10 μm was significantly lowered to 194.3° C. as shown in Table 7, but an exothermic peak was extremely suppressed to 90.1 J/g. This is due to the fact that a doping amount of Zr contributing to improving the thermal stability is much higher than that of particles having different diameters. In addition, as the particle size of the classified particles was increased, both a heat generation onset temperature and the peak temperature gradually increased depending on a result of DSC measurement.

The onset temperature is decreased to 204.2° C. and the peak temperature is decreased to 215.1° C. for the positive electrode active material of Comparative Example 3 in which the length of the core portion is 75% or more, but the doping is performed. In particular, it can be seen that the heat generation amount is 1330 J/g, which is 26 times higher than that at an average particle diameter before the classification in Example 1.

On the other hand, as a result of DSC measurement, the positive electrode active material of Example 2 was found to be almost uniform with no large difference in peak temperature for each particle diameter. Particularly, in Example 2, it can be seen that both the heat generation onset temperature and the peak temperature are high compared to each similar particle diameter. In particular, it should be noted that a heat generation amount of Example 2 is significantly reduced as compared with Comparative Example 2.

Therefore, it can be seen from the result of DSC measurement that the positive electrode active material of Example 2 has significantly improved thermal stability as compared with Comparative Examples 2 and 3.

It can be seen that the heat generation amount is in a range of 510 to 610 J/g, showing that the thermal stability is greatly improved, for the positive electrode active material of Example 3 in which a mole ratio of zirconium was adjusted to 0.003 mol in the entire particles, Example 4 in which it was adjusted to 0.002 mol, and Example 5 in which it was adjusted to 0.005 mol.

Next, it can be seen that the heat generation amount is about half of that of Comparative Example 3, showing that the thermal stability is improved in the case of Reference Example 1 in which the length and particle composition of the core portion are the same as in Example 2 but differ only in the angle formed by the curves indicating the nickel molar contents of the core portion and the shell portion as compared with Comparative Example 3.

### Evaluation Example 6 (Measurement of DC-IR Increase Rate of Positive Electrode Active Material)

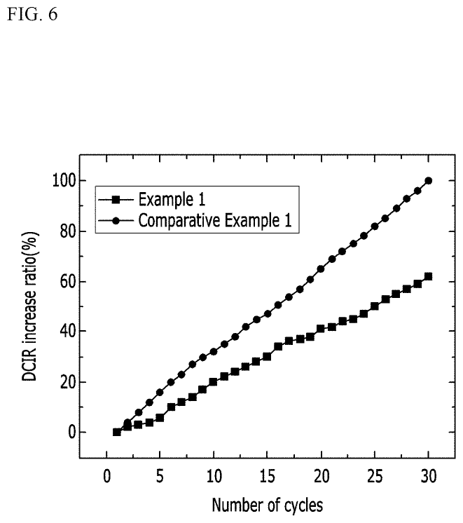

A direct current internal resistance (DC-IR) according to performance of the charge and discharge cycle was measured using the positive electrode active materials before classification in Examples 1 and 2 and Comparative Examples 1 to 3, and an IC-IR increase rate is shown in FIG. 6 and Table 8.

DC-IR is an index of the possibility of high-speed charge depending on the cycle performance, and recently it has been strictly controlled as a positive electrode material specification in the manufacture of batteries for electric vehicles.

This DC-IR characteristic may be allowed to clearly distinguish an effect when measured at a high temperature.

Therefore, it was measured in a constant-temperature chamber maintained at 45° C., and as the charging and discharging cycles proceeded, the voltage was measured 60 seconds after a discharge current was applied assuming that a 4.25 V charge was a fully charged state (100%).

Thereafter, an initial DC-IR value was converted into 0, and after 30 cycles, the increase rate of the DC-IR value was expressed as a percentage in the case of FIG. 6 (Example 1 and Comparative Example 1).

In the case of Examples 2 to 5, Comparative Examples 2 and 3, and Reference Example 1, the DC-IR value in a 1^{st} cycle and the DC-IR value in a 30^{th} cycle are shown, and an increase amount thereof is shown in Table 8 below.

TABLE 8

| | | | 30^{th} | | |
|---|---|---|---|---|---|
| | | 1^{st} | DC- | Increasing | Increasing |
| | | DC-IR | IR | amount | rate |
| Division | | [Ω] | [Ω] | [Ω] | [%] |
| Example 2 | Before classified | 17 | 27.2 | 10.2 | 60 |
| | (D50 14.21 μm) | | | | |
| Comparative | Before classified | 19 | 38 | 19 | 100 |
| Example 2 | (D50 12.97 μm) | | | | |
| Comparative | Before classified | 23 | 62.1 | 39.1 | 170 |
| Example 3 | (D50 14.31 μm) | | | | |
| Example 3 | Before classified | 17.5 | 28.4 | 10.9 | 62.3 |
| | (D50 14.15 μm) | | | | |
| Example 4 | Before classified | 18 | 30.2 | 12.2 | 67.8 |
| | (D50 14.02 μm) | | | | |
| Example 5 | Before classified | 17 | 28.1 | 11.1 | 65.3 |
| | (D50 14.35 μm) | | | | |
| Reference | Before classified | 19.2 | 37.7 | 18.5 | 96.4 |
| Example 1 | (D50 14.19 μm) | | | | |

Referring to FIG. 6, as in Comparative Example 1, when a retention time of the co-precipitation step for forming the core portion is shortened, a difference in the concentration of nickel is greatly formed depending on the particle size. As a result, it can be seen that the DC-IR increase rate is greatly increased by 30 times to about 100% in a characteristic evaluation of the lithium rechargeable battery using the positive electrode active material of Comparative Example 1.

On the other hand, in the case of Example 2, it can be seen that even after 30 cycles of charging and discharging, the increase rate of the DC-IR value is about 60%, which is significantly reduced as compared with Comparative Example 2.

Accordingly, it can be seen that when the positive electrode active material in which a length of the core portion is increased and having a concentration gradient in which the molar content of the shell portion is rapidly reduced is applied, it is very effective in manifesting performance of the lithium rechargeable battery.

Referring to Table 8, as in Comparative Example 2, when a retention time of the co-precipitation step for forming the core portion is shortened, a difference in the concentration of nickel is greatly formed depending on the particle size. As a result, it can be seen that the DC-IR increase rate is greatly increased by 30 times to about 100% in a characteristic evaluation of the lithium rechargeable battery using the positive electrode active material of Comparative Example 1.

In addition, it can be seen that the initial resistance is as high as 23Ω, and the increase rate greatly increases by as much as 170% for the positive electrode active material of Comparative Example 3 in which the length of the core portion is 75% or more, but the doping is performed.

On the other hand, it can be seen that the increase rate of the DC-IR value is about 60% even after 30 cycles of charging and discharging in the case of Example 2, while the increase rate of the DC-IR value is about 68% at a maximum, which is significantly reduced as compared with Comparative Examples 2 and 3 in the case of Examples 3 to 5 in which only the molar ratio of Zr is adjusted in the entire particles.

Next, it can be seen that the resistance increase rate is reduced to about half of that of Comparative Example 3 in the case of Reference Example 1 in which the length and particle composition of the core portion are the same as in Example 2 but differ only in the angle formed by the curves indicating the nickel molar contents of the core portion and the shell portion as compared with Comparative Example 3.

When the results of the above and the evaluation examples are referenced, it can be seen that when the doping element is included and the positive electrode active material in which a length of the core portion is increased and having a concentration gradient in which the molar content of the shell portion is rapidly reduced is applied as in the examples of the present invention, this is very effective in manifesting performance of the lithium rechargeable battery.

The present invention may be embodied in many different forms, and should not be construed as being limited to the disclosed embodiments. In addition, it will be understood by those skilled in the art that various changes in form and details may be made thereto without departing from the technical spirit and essential features of the present invention. Therefore, it is to be understood that the above-described exemplary embodiments are for illustrative purposes only, and the scope of the present invention is not limited thereto.

1. A positive electrode active material precursor for a lithium rechargeable battery, the precursor comprising:
a core portion having a constant molar content of nickel; and
a shell portion surrounding an outer surface of the core portion and having a concentration gradient in which a molar content of nickel gradually decreases in a direction from an interface with the core portion to an outermost portion thereof,
wherein the positive electrode active material precursor includes a nickel-based metal hydroxide particle having a value of 50% or more of Formula 1:
R1/(R1+D1)*100% [Formula 1]
wherein, in Formula 1, R1 indicates a radius of the core portion in the nickel-based metal hydroxide particle, and D1 indicates a thickness of the shell portion in the nickel-based metal hydroxide particle.

2. The positive electrode active material precursor of claim 1, wherein
the nickel-based metal hydroxide particles
an angle formed by a curve representing the nickel molar content of the core portion and a curve representing the nickel molar content of the shell portion is in the range of 95.1° to 141.3°.

3. The positive electrode active material precursor of claim 1, wherein
a value of Formula 2 is greater than or equal to 75%.

4. The positive electrode active material precursor of claim 1, wherein
the nickel-based lithium metal oxide particle includes a plurality of nickel-based lithium metal oxide particles, and
a difference in Ni content between the nickel-based metal hydroxide particles is 3% or less.

5. The positive electrode active material precursor of claim 1, wherein
the positive electrode active material resulting from the nickel-based metal hydroxide particles has a heat generation amount of 650 J/g or less.

6. The positive electrode active material precursor of claim 1, wherein
the nickel-based metal hydroxide particle
is a large particle-diameter active material precursor particle having a D50 of 10 to 30 μm.

7. The positive electrode active material precursor of claim 1, wherein
an average composition of the nickel-based metal hydroxide particle
is represented by the following Chemical Formula 1:
Ni_{1-w1-x1-y1-z1}Co_{w1}M1ₓ₁M2_{y1}M3_{z1}(OH)₂₋ₚ₁Xₚ₁ DeletedTexts [Chemical Formula 1]
wherein, in Chemical Formula 1,
each of M1, M2, and M3 is one element selected from the group consisting of Mn, Al, Mg, Zr, Sn, Ca, Ge, Ga, B, Ti, Mo, Nb, and W,
X is one element selected from the group consisting of F, N, and P, and
each of w1, x1, y1, z1, and p1 satisfies a following corresponding inequality: 0<w1≤0.2, 0<x1≤0.2, 0≤y1≤0.1, 0≤z1≤0.1, 0<w1+x1+y1+z1≤0.4, and 0≤p1≤0.1.

8. A preparation method of a positive electrode active material precursor for a lithium rechargeable battery, the method comprising:
a preparation step of a first metal salt aqueous solution and a second metal salt aqueous solution, each of which contains a nickel source material, a dissimilar metal source material, and water, wherein molar concentrations of the nickel source material are different in the first metal salt aqueous solution and the second metal salt aqueous solution;
a first co-precipitation step of forming a core portion by supplying the first metal salt aqueous solution to a reactor having a pH that is constantly maintained, to which a chelating agent is supplied; and
a second co-precipitation step of forming a shell portion surrounding an outer surface of the core portion by gradually decreasing a supply rate of the first metal salt aqueous solution and by gradually increasing a supply rate of the second metal salt aqueous solution, after the first co-precipitation step,
wherein a nickel-based metal hydroxide particle including the core portion and the shell portion is obtained in the second co-precipitation step, and the first co-precipitation step and the second co-precipitation step are controlled to obtain a value of 50% or more of Formula 1 for the obtained nickel-based metal hydroxide particle:
R1/(R1+D1)*100% [Formula 1]
wherein, in Formula 1, R1 indicates a radius of the core portion in the nickel-based metal hydroxide particle, and D1 indicates a thickness of the shell portion in the nickel-based metal hydroxide particle.

9. The preparation method of claim 8, wherein
the first co-precipitation step and the second co-precipitation step are controlled to satisfy Formula 2:
log T1/log(T1+T2)≈R1/(R1+D1) [Formula 2]
wherein, in Formula 2, T1 is an execution time of the first co-precipitation step, and T2 is an execution time of the second co-precipitation step.

10. The preparation method of claim 9, wherein
the first co-precipitation step
is performed for 10 hours or more.

11. The preparation method of claim 10, wherein
in the first co-precipitation step,
particles having a radius of R1 from a center and a constant molar content of nickel in the entire region are precipitated.

12. The preparation method of any one of claim 8 to claim 11, wherein
in the second co-precipitation step,
shell portions are formed by using the particles precipitated in the first co-precipitation step as core portions to have a thickness of R2 from surfaces of the core portions and a molar content of nickel that gradually decreases in a thickness direction from interfaces with the surfaces of the core portions, and
nickel-based metal hydroxide particles formed to include the core portion and the shell portion are obtained.

13. A positive electrode active material for a lithium rechargeable battery, the material comprising:
a core portion having a constant molar content of nickel; and
a shell portion surrounding an outer surface of the core portion and having a concentration gradient in which a molar content of nickel gradually decreases in a direction from an interface with the core portion to an outermost portion thereof,
wherein the positive electrode active material precursor includes a nickel-based lithium metal oxide particle having a value of 50% or more of Formula 3:
R2/(R2+D2)*100% [Formula 3]
wherein, in Formula 3, R2 indicates a radius of the core portion in the nickel-based metal oxide particle, and D2 indicates a thickness of the shell portion in the nickel-based metal oxide particle.

14. The positive electrode active material of claim 13, wherein
an angle formed by a curve representing the nickel molar content of the core portion and a curve representing the nickel molar content of the shell portion is in the range of 95.1° to 141.3°.

15. The positive electrode active material of claim 13, wherein
a value of Formula 2 is greater than or equal to 75%.

16. The positive electrode active material of claim 13, wherein
the nickel-based lithium metal oxide particle
is a large particle-diameter active material particle having a D50 of 10 to 30 μm.

17. The positive electrode active material of claim 13, wherein
an average composition of the nickel-based lithium metal oxide particle
is represented by the following Formula 4:
Li₁₊ₘ[Ni_{1-w4-x4-y4}Co_{w4}M1ₓ₄M2_{y4}]_{1-z4}M3_{z4}O₂₋ₚ₄Xₚ₄ [Chemical Formula 4]
wherein, in Chemical Formula 4,
each of M1, M2, and M3 is one element selected from the group consisting of Mn, Al, Mg, Zr, Sn, Ca, Ge, Ga, B, Ti, Mo, Nb, and W,
X is one element selected from the group consisting of F, N, and P,
each of w4, x4, y4, z4, and p4 satisfies a following corresponding inequality: 0<w4≤0.2, 0<x4≤0.2, 0≤y4≤0.1, 0≤z4≤0.1, 0<w4+x4+y4+z4≤0.4, and 0≤p1≤0.1, and
m satisfies an inequality: −0.05≤m≤0.25.

18. The positive electrode active material of claim 13, wherein
the nickel-based lithium metal oxide particle includes a plurality of nickel-based lithium metal oxide particles, and
a difference in Ni content between the nickel-based metal oxide particles is 3% or less.

19. The positive electrode active material of claim 13, wherein
the positive electrode active material has a heat generation amount of 650 J/g or less.

20. The positive electrode active material of claim 13, further comprising
a coating layer configured to surround an outer surface of the shell portion,
wherein the coating layer includes at least one of an element of B, Mg, Zr, Al, Mn, Co, or a combination thereof, an oxide of the element, an amorphous compound thereof, a lithium ion conductive oxide thereof, and a polymer thereof.
